(19) United States
(12) Patent Application Publication
(10) Pub. No.: US 2025/0376168 A1
(43) Pub. Date: Dec. 11, 2025

(54) STEERING CONTROL DEVICE AND METHOD

(71) Applicant: HL KLEMOVE CORP., Incheon (KR)

(72) Inventor: ShuBo SUN, Incheon (KR)

(21) Appl. No.: 18/927,634

(22) Filed: Oct. 25, 2024

(30) Foreign Application Priority Data
Jun. 11, 2024 (KR) 10-2024-0075722

(51) Int. Cl. B60W 30/18; B60W 10/20; B60W 30/165

(52) U.S. Cl. CPC B60W 30/18163; B60W 10/20; B60W 30/165; B60W 2520/10; B60W 2555/60

(57) ABSTRACT

The present embodiments relate to a steering control device and method. Specifically, a steering control device according to an embodiment may include a receiver for receiving driving information around a host vehicle from a plurality of sensors, a determiner configured to determine whether to execute an overtaking operation based on the driving information and a vehicle speed of the host vehicle, and a controller configured to output a control signal for a lane change in response to determine to execute the overtaking operation.

### CROSS REFERENCE TO RELATED APPLICATION

This application claims priority from Korean Patent Application No. 10-2024-0075722, filed on Jun. 11, 2024, which is hereby incorporated by reference for all purposes as if fully set forth herein.

### TECHNICAL FIELD

An embodiment of the present disclosure relates to a steering control device and a steering control method.

### BACKGROUND

An advanced driving assistance system (ADAS) is an advanced driver assistance system which monitors the situation in front of a host vehicle to acquire information, and utilizes the information to determine the situation and assist a driver in driving or control the vehicle.

The ADAS may detect the driving environment and traffic environment using various sensors, radar, lidar, cameras, etc. installed in a vehicle and provide information on the driving environment and traffic environment to the driver, or may provide a function of controlling the speed and braking of the vehicle to assist driving.

The ADAS may provide functions that assist driving by controlling the longitudinal speed of a driving vehicle, such as adaptive cruise control (ACC), or controlling the lateral direction of a driving vehicle, such as lane departure warning system (LDWS) or lane change system.

These functions may utilize information of a plurality of sensors, and there is required actions appropriate to the situation.

### SUMMARY

Embodiments of the present disclosure are to provide a device and a method capable of controlling a lane change behavior of a vehicle by setting a plurality of conditions based on the vehicle's speed and surrounding environment.

In accordance with an aspect of the present disclosure, there may be provided a steering control device including a receiver for receiving driving information around a host vehicle from a plurality of sensors, a determiner configured to determine whether to execute an overtaking operation based on the driving information and a vehicle speed of the host vehicle, and a controller configured to output a control signal for a lane change in response to determine to execute the overtaking operation.

In accordance with another aspect of the present disclosure, there may be provided a steering control method including receiving driving information around a host vehicle from a plurality of sensors, determining whether to execute an overtaking operation based on the driving information and a vehicle speed of the host vehicle, and outputting a control signal for a lane change in response to determine to execute the overtaking operation.

In accordance with another aspect of the present disclosure, there may be provided a steering control device including at least one memory storing computer program instructions, and at least one processor executing the computer program instructions, wherein the at least one processor is configured to determines whether to execute an overtaking operation based on driving information around a host vehicle received from a plurality of sensors and a vehicle speed of the host vehicle, and output a control signal for a lane change in response to determine to execute the overtaking operation.

According to an embodiment of the present disclosure, it is possible to provide a steering control device and method capable of controlling a lane change behavior of a vehicle by setting a plurality of conditions based on the vehicle's speed and surrounding environment.

### BRIEF DESCRIPTION OF THE DRAWINGS

FIG. 1 is a block diagram for explaining a steering control device according to one embodiment of the present disclosure.

FIG. 2 is a diagram for specifically explaining a step of a Slow-Fast-Slow lane change according to an embodiment.

FIG. 3 is a diagram for explaining determining a Slow-Fast-Slow lane change by utilizing surrounding information received from a plurality of sensors according to an embodiment.

FIG. 4 is a flowchart for explaining a steering control method according to an embodiment of the present disclosure.

FIG. 5 is a flowchart for more specifically explaining step S420 according to an embodiment.

FIG. 6 is a block diagram of an exemplary computing system.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described a steering control device according to an embodiment of the present disclosure with reference to the attached drawings.

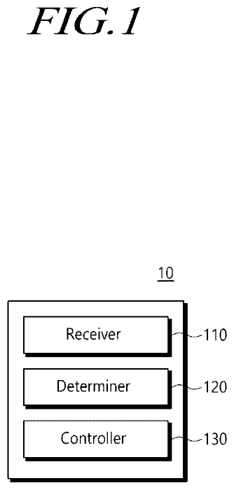

FIG. 1 is a block diagram for explaining a steering control device 10 according to an embodiment of the present disclosure.

A steering control device 10 according to an embodiment may include a receiver 110, a determiner 120, and a controller 130.

In one embodiment, the steering control device 10 may be an ADAS (Advance Driver Assistance Systems) capable of providing information to assist driving of a vehicle or assists a driver in controlling the vehicle.

Here, ADAS may refer to various types of advanced driver assistance systems, and advanced driver assistance systems may include, for example, an Autonomous Emergency Braking (AEB) System, a Smart Parking Assistance System (SPAS), a Blind Spot Detection (BSD) system, an Adaptive Cruise Control (ACC) system, a Lane Departure Warning System (LDWS), a Lane Keeping Assist System (LKAS), a Lane Change Assist System (LCAS), and so on. However, the present disclosure is not limited thereto.

The steering control device 10 according to the present disclosure may be installed in a manned vehicle in which a driver rides and controls the vehicle or an autonomous vehicle.

The steering control device 10 may receive driving information around a host vehicle from a plurality of sensors, and may determine whether to execute an overtaking operation based on the driving information and a vehicle speed of the host vehicle, and may output a control signal for a lane change in case of determining to executing the overtaking operation.

The receiver 110 may receive driving information around the host vehicle from a plurality of sensors.

The plurality of sensors may include, for example, a vehicle speed sensor, a radar sensor, a Lidar sensor, a yaw-rate sensor, and a camera sensor. The receiver 110 may receive each sensing information from the sensors to be used in determining whether to execute an overtaking operation of the present disclosure.

In this specification, the execution of the overtaking operation may be exemplified and described as “Slow-Fast-Slow lane change.” This may refer to an action of the vehicle changing from a slow lane to a fast lane and then back to a slow lane. The overtaking operation and the Slow-Fast-Slow lane change operation may be understood as having the same meaning. In addition to simply changing the vehicle from a slow lane to a fast lane, the host vehicle may also change from a fast lane to a slow lane again if the vehicle is slow, thereby preventing unnecessary traffic congestion.

Hereinafter, for the convenience of understanding, the execution of the overtaking operation described above may be described as “Slow-Fast-Slow lane change.”

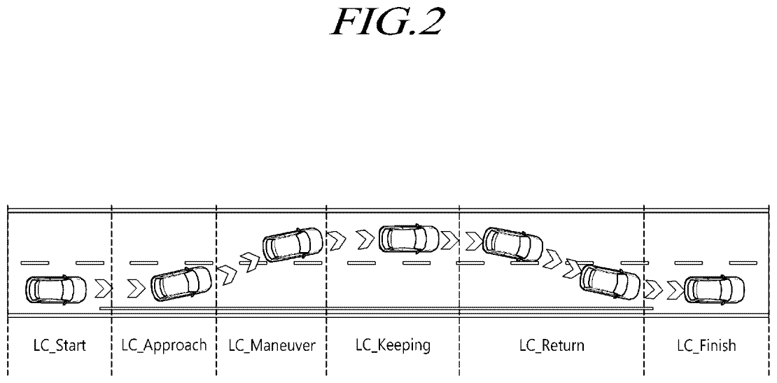

FIG. 2 is a diagram for specifically explaining the steps of the Slow-Fast-Slow lane change according to an embodiment.

Referring to FIG. 2, the Slow-Fast-Slow lane change may include steps such as Start, Approach, Maneuver, Keeping, Return, and Finish.

Specifically, the LC_Start step may start changing lanes after a driver inputs a turn signal. Here, this may mean a state in which the host vehicle has not performed an operation for the lane change.

The LC Approach step may mean a driving state before the front tires of the host vehicle touch the lane after the lane change starts. To this end, the receiver 110 may receive each sensing information from a yaw rate sensor, a camera sensor, etc.

The LC Maneuver step may mean a driving state until the rear tires of the host vehicle pass the lane.

The LC_Keeping step may mean steps of setting a vehicle which can be followed in the fast lane while the lane change continues and maintaining the following the set vehicle. Here, the LC_Keeping step may include performing a determination on whether of a collision with a surrounding vehicle in order to change lanes to the lane before changing.

The LC_Return step may mean a stage of changing lanes again from the fast lane to the slow lane.

The LC_Finish step may mean a step of completing a lane change and changing a lane following status by setting another vehicle in a slow lane as a preceding vehicle to be followed.

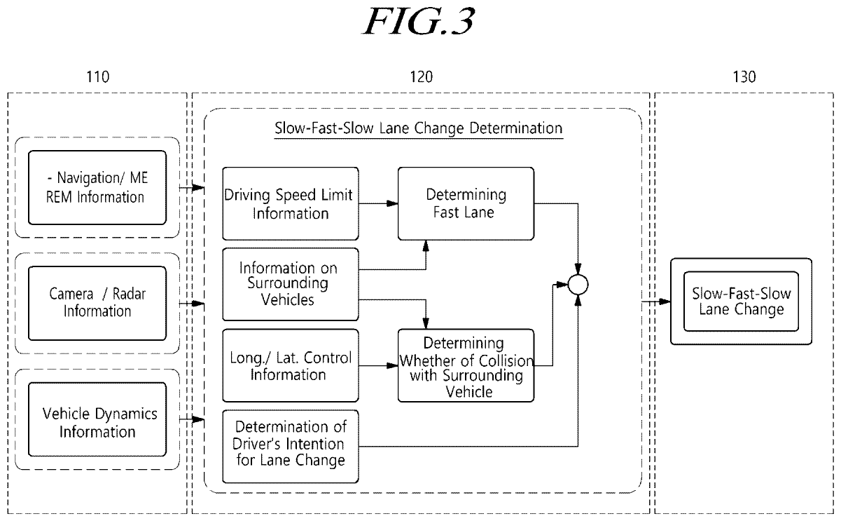

FIG. 3 is a diagram for explaining determining a Slow-Fast-Slow lane change by utilizing surrounding information received from a plurality of sensors according to an embodiment.

Referring to FIG. 3, the receiver 110 may receive sensing information from the plurality of sensors, and may receive navigation information or a road experience management (REM) information from an externally installed server through a network, or may store and use navigation information or REM information in a database within the vehicle.

Specifically, the receiver 110 may receive navigation information, REM information, and ME REM (MobilEye Road Experience Management) information. That is, the receiver 110 may obtain detailed map information around the vehicle.

The navigation information may include a unique location information. In detail, the navigation information may include the current location information of the host vehicle using the GPS (Global Positioning System), and the confirmed location information may be used as basic data for calculating the driving route.

In addition, the navigation information may include an optimal route information to a destination by considering the traffic conditions. For example, if a driver inputs a destination by operating the control devices or by voice, the optimal route to the destination may be calculated based on the current location information and data in the map memory. Here, the optimal route information may include real-time traffic information collected through various information and communication systems including Traffic Information System (TIM), Radio Data System (RDS) or the Internet, which may be considered in calculating the distance to the destination. The real-time traffic information may include information on a congested section, a construction section, a road block, etc.

In addition, the navigation information may include information for guiding the host vehicle to the destination along the calculated optimal route. Furthermore, the navigation information may provide not only road information but also speed limits and other various information.

The REM information may include a high-precision map which is generated and updated based on data collected while the autonomous vehicle is driving on the road. Such a map may include the accurate information on details of the road (e.g., lanes, signs, traffic lights, etc.).

In addition, the REM information may include cloud-based shared data. The host vehicle may download and use road information collected by other vehicles while driving and uploaded to a cloud server. Through this, the REM information may be utilized including the latest road information.

The receiver 110 may receive radar information and camera information. The radar information may mean the result detected by a radar sensor around the vehicle, and may include the presence of objects detected around the vehicle, the speed of the objects, the distance to the objects, etc.

Specifically, the receiver 110 may receive radar information from the radar sensor. In one embodiment, the receiver 110 may receive radar information on the detection of the surroundings of the vehicle from a plurality of radar sensors mounted on the vehicle. For example, the receiver 110 may receive radar information from a front radar sensor detecting the front, a side-rear radar sensor detecting the side-rear, etc.

The camera information may refer to image data captured by a camera sensor around the vehicle. The present disclosure may detect an object or determine a surrounding situation by utilizing the camera information.

The determiner 120 may determine whether to execute an overtaking operation based on the driving information and a vehicle speed of the host vehicle.

Specifically, the determiner 120 may determine a fast lane based on road speed limit information and information on surrounding vehicles. The road speed limit information may be obtained through navigation information, REM information, and signs captured by the camera sensor, and the information on surrounding vehicles may be obtained through radar information, camera information, and the like. The information on surrounding vehicles may include the location information, speed information, driving lane information of another vehicle detected around the host vehicle.

The determiner 120 may determine an average speed of an adjacent lane from a vehicle driving in an overtaking lane and determine whether the adjacent lane is a faster lane than the driving lane. The average speed of the adjacent lane may mean the average value of the driving speeds of vehicles driving in the adjacent lane.

The determiner 120 may determine whether there is a collision with a surrounding vehicle based on the information of surrounding vehicles and the longitudinal/lateral control information of the host vehicle.

Specifically, the longitudinal/lateral control information of the host vehicle may be acquired based on the yaw rate information and steering angle information of the host vehicle.

The determiner 120 may determine whether there is a collision with a surrounding vehicle when changing lanes or driving in the driving lane based on the acquired information of surrounding vehicles and the longitudinal/lateral control information of the host vehicle.

The determiner 120 may determine whether to execute an overtaking operation by determining a fast lane, determining of a collision with a surrounding vehicle, and determining the driver's intention to change lanes.

The determiner 120 may determine to execute an overtaking operation if there is a preceding vehicle in front of the driving lane in which the host vehicle is driving and a condition for executing an overtaking operation for the preceding vehicle is satisfied. Here, the preceding vehicle may be a followed vehicle which the host vehicle is following. The followed vehicle may refer to a target vehicle on which the host vehicle performs a Smart Cruise Control (ACC) or an Adaptive Cruise Control (ACC) function.

The determiner 120 may determine that the condition for executing an overtaking operation is satisfied if the vehicle speed of the host vehicle is less than a value obtained by subtracting a reference value from a predetermined specific speed. For example, the predetermined specific speed may be a set speed set for the host vehicle to follow a preceding vehicle or a road speed limit. That is, the condition for executing an overtaking operation may be determined to be satisfied if the vehicle speed of the host vehicle is less than the set speed of the host vehicle for following a preceding vehicle by a reference value. Alternatively, the condition for executing an overtaking operation may be determined to be satisfied if the vehicle speed of the host vehicle is less than the road speed limit by a reference value.

That is, in this case, there may be determined that the host vehicle is required to overtake the preceding vehicle. However, if the host vehicle simply changes lanes and enters an overtaking lane, traffic congestion may occur in the overtaking lane. Therefore, the determiner 120 may further determine whether the host vehicle needs to change back from the overtaking lane to the previous driving lane.

For example, the determiner 120 may further use the comparison result of comparing an average speed of the overtaking lane adjacent to the driving lane and an average speed of the driving lane to determine whether to execute the overtaking operation. In this case, the average speed of the driving lane may be an average value of the driving speeds of vehicles driving in the previous driving lane, and in some cases, the average speed of the driving lane may be the vehicle speed of the host vehicle just before changing lanes.

The determiner 120 may determine to execute the overtaking operation if the average speed of the overtaking lane is greater than the average speed of the driving lane, and the vehicle speed or the set speed of the host vehicle is less than the average speed of the overtaking lane. For example, if the host vehicle changes from the driving lane to the overtaking lane when a cruise control speed set for the host vehicle is lower than the average speed of the overtaking lane, there may occur a traffic congestion in the overtaking lane. Therefore, the determiner may compare the average speed of the overtaking lane and the vehicle speed or set speed of the host vehicle so that the host vehicle may pass or overtake the preceding vehicle in the driving lane and then return or change a lane again to the previous driving lane.

The determiner 120 may utilize the REM information when performing the overtaking operation. The determiner 120 may further utilize navigation information and ME REM information to determine whether to perform the overtaking operation. For example, the determiner 120 may determine the average speed of the driving lane and the average speed of the overtaking lane using the REM information.

The present disclosure may utilize the REM information to determine an efficient vehicle trajectory and a vehicle speed suitable for performing the overtaking operation by utilizing detailed road information and surrounding information.

Meanwhile, the reference value may be a predetermined value, for example, 5 km/h.

In one embodiment, the determiner 120 may determine to execute an overtaking operation if the vehicle speed of the host vehicle is preset, and the preset vehicle speed is less than a value obtained by subtracting the reference value from the road speed limit of the driving lane.

The vehicle speed of the host vehicle may be determined for a predetermined time period, and the value of the vehicle speed of the host vehicle may be compared with a value of another speed, for example, for 1 second.

In addition, according to the embodiment of the present disclosure, the host vehicle may change the lane from the slow lane to the fast lane, and then change the lane back to the slow lane.

In addition, according to the embodiment of the present disclosure, the host vehicle may perform a lane change back to the previous driving lane after overtaking the vehicle in front of the driving lane through the lane change function.

If it is determined to execute the overtaking operation, the controller 130 may output a control signal to control the host vehicle to change from the driving lane to the overtaking lane, and to control the host vehicle to change again from the overtaking lane to the driving lane after overtaking the preceding vehicle.

Hereinafter, it will be described a steering control method using a steering control device 10 capable of performing all functions described in the present disclosure.

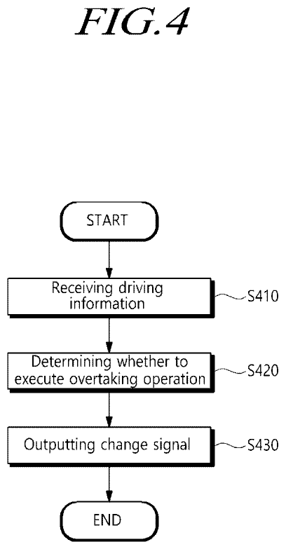

FIG. 4 is a flowchart for explaining a steering control method according to an embodiment of the present disclosure.

Referring to FIG. 4, a steering control method according to an embodiment of the present disclosure may include a step (S410) of receiving driving information around a host vehicle from a plurality of sensors, a step (S420) of determining whether to execute an overtaking operation based on the driving information and a vehicle speed of the host vehicle, and a step (S430) of outputting a control signal for changing lanes when it is determined to execute the overtaking operation.

The step (S420) of determining whether to execute an overtaking operation may include determining whether to execute an overtaking operation if a preceding vehicle exists in front of a driving lane in which the host vehicle is driving and a condition for executing the overtaking operation for the preceding vehicle is satisfied.

The step (S420) of determining whether to execute an overtaking operation may include determining that the condition for executing the overtaking operation is satisfied if the vehicle speed of the host vehicle is less than a value obtained by subtracting a reference value from a predetermined specific speed. Here, the predetermined specific speed may be a set speed set for the host vehicle to follow the preceding vehicle or a road limit speed.

The step (S420) of determining whether to execute the overtaking operation may further include utilizing the comparison result of comparing an average speed of an overtaking lane adjacent to the driving lane and an average speed of the driving lane to determine whether to execute the overtaking operation.

For example, the step (S420) of determining whether to execute the overtaking operation may include determining to execute the overtaking operation if an average speed of a vehicle capable of being followed in the overtaking lane is greater than the vehicle speed of the host vehicle.

The step (S420) of determining whether to execute the overtaking operation may include determining to execute the overtaking operation if the average speed of the overtaking lane is greater than the average speed of the driving lane, and the vehicle speed or the set speed of the host vehicle is less than the average speed of the overtaking lane.

Meanwhile, the step S420 of determining whether to execute the overtaking operation may include determining to execute the overtaking operation if REM information is available.

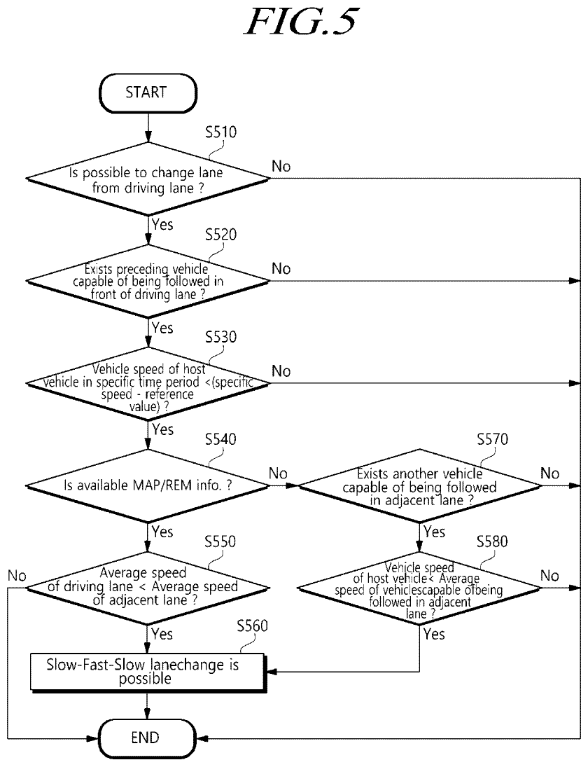

FIG. 5 is a flowchart for more specifically explaining step S420 according to an embodiment.

Referring to FIG. 5, the steering control device 10 may determine whether the host vehicle can perform a lane change from the driving lane (S510). The steering control device 10 may receive detection results such as distance and time from a vehicle in front of the driving lane and a vehicle in the adjacent lane (i.e., overtaking lane), and determine whether the host vehicle can perform a lane change based on the detection results.

If the host vehicle can perform a lane change from the driving lane (Yes in S510), the steering control device 10 may determine whether there is a vehicle (e.g., a preceding vehicle) which can be followed in front of the driving lane (S520). The steering control device 10 may determine whether there is a preceding vehicle which can be followed or is being followed in front of the driving lane based on radar information and camera information.

If there is a preceding vehicle in front of the driving lane (Yes in S520), the steering control device 10 may determine whether the vehicle speed of the host vehicle is smaller than a value obtained by subtracting a reference value from a predetermined specific speed for a predetermined period of time (S530). Here, the vehicle speed of the host vehicle is a preset speed, and the predetermined specific speed may be replaced with a vehicle speed limit of a road on which the host vehicle is driving.

If the vehicle speed of the host vehicle is less than a value which is reduced by a reference value from a predetermined specific speed (Yes in S530), the steering control device 10 may determine whether MAP/REM information is available (S540). The steering control device 10 may utilize navigation information, REM information, and ME REM information to change the lane of the host vehicle.

If MAP/REM information is available (Yes of S540), the steering control device 10 may determine whether an average vehicle speed of the driving lane is lower than an average vehicle speed of an adjacent lane (S550). The steering control device 10 may determine the average speed of the adjacent lane by detecting the speed of the vehicles driving in the adjacent lane.

If the average vehicle speed of the driving lane is lower than the average vehicle speed of the adjacent lane (Yes of S550), the steering control device 10 may determine that a Slow-Fast-Slow lane change (e.g., execution of overtaking operation) is possible (S560).

If MAP/REM information is not available (No of S540), the steering control device 10 may determine whether there is a vehicle which can be followed in the adjacent lane (S570).

If there is a vehicle which can be followed in the adjacent lane (Yes in S570), the steering control device 10 may determine whether the vehicle speed of the host vehicle is lower than an average vehicle speed of a vehicle capable of being followed in the adjacent lane (S580).

If the vehicle speed of the host vehicle is lower than the average vehicle speed of the vehicle which can be followed in the adjacent lane (Yes in S580), the steering control device 10 may determine that a Slow-Fast-Slow lane change (i.e., execution of an overtaking operation) is possible (S560).

As described above, according to the present disclosure, by performing a single Slow-Fast-Slow lane change, there may be omitted an additional operation occurring in performing the conventional lane change function.

In addition, according to the embodiment of the present disclosure, it is possible to flexibly deal with the difference in vehicle speed of the host vehicle occuring when the host vehicle performs two lane changes and returns to the original lane.

Meanwhile, an embodiment of the present disclosure may provide a steering control device for implementing the above-described device and/or method. For example, a steering control device may be implemented as a computing system.

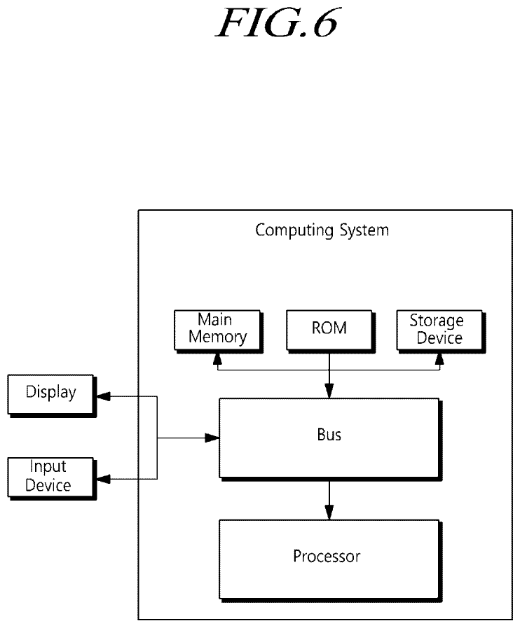

FIG. 6 is a block diagram of an exemplary computing system.

A vehicle control device according to an embodiment may include at least one memory including computer program instructions and at least one processor executing the computer program instructions.

For example, at least one processor may determine whether to execute an overtaking operation based on driving information around a host vehicle and a vehicle speed of the host vehicle received from a plurality of sensors, and output a control signal for changing lanes if the execution of the overtaking operation is determined.

In addition, at least one processor may determine to execute an overtaking operation if a preceding vehicle exists in front of a driving lane in which the vehicle is driving and a condition for executing the overtaking operation for the preceding vehicle is satisfied.

In addition, at least one processor may determine that the condition for executing the overtaking operation is satisfied if the vehicle speed of the host vehicle is less than a value obtained by subtracting a reference value from a set speed set for the vehicle to follow the preceding vehicle or the road speed limit.

At least one processor may further utilize the comparison result of comparing an average speed of the overtaking lane adjacent to the driving lane and an average speed of the driving lane to determine whether to execute the overtaking operation.

At least one processor may determine to execute the overtaking operation if the average speed of the overtaking lane is greater than the average speed of the driving lane, and the vehicle speed or the set speed of the host vehicle is less than the average speed of the overtaking lane.

In addition, at least one processor may output a control signal for controlling the host vehicle to change from the driving lane to the overtaking lane and to change again from the overtaking lane to the previous driving lane after overtaking the preceding vehicle.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steering control device comprising:
a receiver for receiving driving information around a host vehicle from a plurality of sensors;
a determiner configured to determine whether to execute an overtaking operation based on the driving information and a vehicle speed of the host vehicle; and
a controller configured to output a control signal for a lane change in response to determine to execute the overtaking operation.

2. The steering control device of claim 1, wherein the determiner determines to execute the overtaking operation if a preceding vehicle exists in front of a driving lane on which the host vehicle is driving and a condition for executing the overtaking operation for the preceding vehicle is satisfied.

3. The steering control device of claim 2, wherein the determiner determines that the condition for executing the overtaking operation is satisfied if the vehicle speed of the host vehicle is less than a value obtained by subtracting a reference value from a predetermined specific speed.

4. The steering control device of claim 3, wherein the predetermined specific speed is a set speed set for the host vehicle to follow the preceding vehicle or a road speed limit.

5. The steering control device of claim 2, wherein the determiner determines whether to execute the overtaking operation further by further using a result of comparing an average speed of an overtaking lane adjacent to the driving lane and an average speed of the driving lane.

6. The steering control device of claim 5, wherein the determiner determines to execute the overtaking operation if the average speed of the overtaking lane is greater than the average speed of the driving lane, and the vehicle speed or the set speed of the host vehicle is less than the average speed of the overtaking lane.

7. The steering control device of claim 1, wherein, in response to determine to execute the overtaking operation, the controller outputs the control signal to control the host vehicle to change from the driving lane to the overtaking lane, and to change again from the overtaking lane to the driving lane after overtaking the preceding vehicle.

8. A steering control method comprising:
receiving driving information around a host vehicle from a plurality of sensors;
determining whether to execute an overtaking operation based on the driving information and a vehicle speed of the host vehicle; and
outputting a control signal for a lane change in response to determine to execute the overtaking operation.

9. The steering control method of claim 8, wherein the determining comprises determining to execute the overtaking operation if a preceding vehicle exists in front of a driving lane on which the host vehicle is driving and a condition for executing the overtaking operation for the preceding vehicle is satisfied.

10. The steering control method of claim 9, wherein the determining comprises determining that the condition for executing the overtaking operation is satisfied if the vehicle speed of the host vehicle is less than a value obtained by subtracting a reference value from a predetermined specific speed.

11. The steering control method of claim 10, wherein the predetermined specific speed is a set speed set for the host vehicle to follow the preceding vehicle or a road speed limit.

12. The steering control method of claim 9, wherein the determining comprises determining whether to execute the overtaking operation further by further using a result of comparing an average speed of an overtaking lane adjacent to the driving lane and an average speed of the driving lane.

13. The steering control method of claim 12, wherein the determining comprises determining to execute the overtaking operation if the average speed of the overtaking lane is greater than the average speed of the driving lane, and the vehicle speed or the set speed of the host vehicle is less than the average speed of the overtaking lane.

14. The steering control method of claim 8, wherein the outputting comprises outputting, in response to determine to execute the overtaking operation, the control signal to control the host vehicle to change from the driving lane to the overtaking lane, and to change again from the overtaking lane to the driving lane after overtaking the preceding vehicle.

15. A steering control device comprising:
at least one memory storing computer program instructions; and
at least one processor executing the computer program instructions,
wherein the at least one processor is configured to determines whether to execute an overtaking operation based on driving information around a host vehicle received from a plurality of sensors and a vehicle speed of the host vehicle, and output a control signal for a lane change in response to determine to execute the overtaking operation.

16. The steering control device of claim 15, wherein the at least one processor determines to execute the overtaking operation if a preceding vehicle exists in front of a driving lane on which the host vehicle is driving and a condition for executing the overtaking operation for the preceding vehicle is satisfied.

17. The steering control device of claim 16, wherein the at least one processor determines that the condition for executing the overtaking operation is satisfied if the vehicle speed of the host vehicle is less than a value obtained by subtracting a reference value from a set speed set for the host vehicle to follow the preceding vehicle or a road speed limit.

18. The steering control device of claim 16, wherein the at least one processor determines whether to execute the overtaking operation further by further using a result of comparing an average speed of an overtaking lane adjacent to the driving lane and an average speed of the driving lane.

19. The steering control device of claim 18, wherein the at least one processor determines to execute the overtaking operation if the average speed of the overtaking lane is greater than the average speed of the driving lane, and the vehicle speed or the set speed of the host vehicle is less than the average speed of the overtaking lane.

20. The steering control device of claim 15, wherein, in response to determine to execute the overtaking operation, the at least one processor outputs the control signal to control the host vehicle to change from the driving lane to the overtaking lane, and to change again from the overtaking lane to the driving lane after overtaking the preceding vehicle.
